(19) United States
(12) Patent Application Publication
(10) Pub. No.: US 2016/0284284 A1
(43) Pub. Date: Sep. 29, 2016

(54) METHOD AND DEVICE FOR ADJUSTING COLOUR TEMPERATURE

(71) Applicant: Xiaomi Inc., Beijing (CN)

(72) Inventors: Anyu LIU, Beijing (CN); Guosheng LI, Beijing (CN); Guilin ZHONG, Beijing (CN)

(73) Assignee: Xiaomi Inc., Beijing (CN)

(21) Appl. No.: 15/078,669

(22) Filed: Mar. 23, 2016

(30) Foreign Application Priority Data
Mar. 24, 2015 (CN) 201510131391 .5

(51) Int. Cl. G09G 3/34; G09G 3/36; G09G 3/20

(52) U.S. Cl. CPC G09G 3/3413; G09G 3/2003; G09G 3/36; G09G 3/3696; G09G 2300/0478; G09G 2320/0242; G09G 2320/0666; G09G 2320/0673

(57) ABSTRACT

A method and a device for adjusting a colour temperature are disclosed. The method includes acquiring a colour coordinate value of a pixel in a Liquid Crystal Display (LCD) is acquired when the LCD displays a white screen, determining whether the colour coordinate value is within a predetermined colour coordinate range corresponding to a predetermined colour temperature of the LCD, and adjusting, if the colour coordinate value is not within the predetermined colour coordinate range, a component value of at least one LED of N LEDs corresponding to the pixel until a changed colour coordinate value of the pixel due to the adjustment falls within the predetermined colour coordinate range.

### CROSS-REFERENCE TO RELATED APPLICATIONS

This application is based upon and claims priority to Chinese Patent Application 201510131391.5, filed on Mar. 24, 2015, the entire contents of which are incorporated herein by reference.

### TECHNICAL FIELD

The present disclosure relates to the field of display technologies, particularly to a method and a device for adjusting a colour temperature.

### BACKGROUND

The colour temperature of a light source refers to the temperature of an ideal black body when the light colour of lights emitted by the light source is the same as the light colour of the ideal black body. Generally, a light source with a low colour temperature emits warm lights while a light source with a high colour temperature emits cool lights.

A Liquid Crystal Display (LCD) includes a backlight module containing Light Emitting Diodes (LED), a light guide plate and liquid crystals. Blue light, red light and green light emitted by different LEDs in the backlight module are deflected and irradiated to the light guide plate by their respective corresponding liquid crystals, and the light guide plate further mixes the three lights to acquire a corresponding display colour of each pixel of the LCD. It can be seen that the colour temperature of the LCD mainly depends on the colour temperatures of the LEDs. If the LEDs have different colour temperatures, then a user senses different colours when the LCD displays a white screen. Therefore, it is necessary to adjust the light temperature of the LCD.

Generally, manufacturers may divide LEDs into blocks according to the colour temperatures of the LEDs, and LEDs in the same block may have similar colour temperatures. Therefore, LEDs from different blocks may be arranged crosswise on an LCD, so that the colour temperature of the LCD acquired by such a mixing method is uniform. For example, a block of LEDs with a colour temperature of 6500 k and a block of LEDs with a colour temperature of 8100 k are arranged crosswise, and the colour temperature of an LCD acquired by such mixing is about 7300 k.

### SUMMARY

The embodiments of the present disclosure provide a method and a device for adjusting a colour temperature to solve the problem that the colour temperature of an LCD is not uniform when LEDs from different blocks are arranged crosswise on the LCD.

According to a first aspect of the embodiments of the present disclosure, there is provided a method for adjusting a colour temperature of the LCD. The method includes acquiring a colour coordinate value of a pixel in an LCD when the LCD displays a white screen, determining whether the colour coordinate value is within a predetermined colour coordinate range corresponding to a predetermined colour temperature of the LCD, and when the colour coordinate value is not within the predetermined colour coordinate range, adjusting a component value of at least one LED of N LEDs corresponding to the pixel until a changed colour coordinate value of the pixel due to the adjustment falls within the predetermined colour coordinate range due to the adjustment. N is a positive integer.

According to a second aspect of the embodiments of the present disclosure, there is provided a device for adjusting a colour temperature of the LCD. The device includes a coordinate acquiring module configured to acquire a colour coordinate value of a pixel in an LCD when the LCD displays a white screen, a coordinate determining module configured to determine whether the colour coordinate value acquired by the coordinate acquiring module is within a predetermined colour coordinate range corresponding to a predetermined colour temperature of the LCD, and a component adjusting module configured to, when the coordinate determining module determines that the colour coordinate value is not within the predetermined colour coordinate range, adjust a component value of at least one LED of N LEDs corresponding to the pixel until a changed colour coordinate value of the pixel due to the adjustment falls within the predetermined colour coordinate range. N is a positive integer.

According to a third aspect of the embodiments of the present disclosure, there is provided a device for adjusting a colour temperature of the LCD. The device includes a processor, a memory for storing instructions executable by the processor. The processor is configured to acquire a colour coordinate value of a pixel in an LCD when the LCD displays a white screen, determine whether the colour coordinate value is within a predetermined colour coordinate range corresponding to a predetermined colour temperature of the LCD, and when the colour coordinate value is not within the predetermined colour coordinate range, adjust a component value of at least one LED of N LEDs corresponding to the pixel until a changed colour coordinate value of the pixel due to the adjustment falls within the predetermined colour coordinate range. N is a positive integer.

It is to be understood that both the foregoing general description and the following detail description are exemplary and explanatory only, and are not restrictive of the invention, as claimed.

### BRIEF DESCRIPTION OF THE DRAWINGS

The accompanying drawings, which are incorporated in the specification and constitute a part of the specification of the present disclosure, illustrate embodiments consistent with the present disclosure, and together with the description, serve to explain the principles of the present disclosure.

FIG. 1 is a flow chart of a method for adjusting a colour temperature according to an exemplary embodiment;

FIG. 2 is a flow chart of a method for adjusting a colour temperature according to another exemplary embodiment;

FIG. 3 is a block diagram of a device for adjusting a colour temperature according to an exemplary embodiment;

FIG. 4 is a block diagram of a device for adjusting a colour temperature according to an exemplary embodiment; and

FIG. 5 is a block diagram of a device for adjusting a colour temperature according to an exemplary embodiment.

### DETAILED DESCRIPTION

The exemplary embodiments will be described in details herein and examples of the exemplary embodiments are illustrated in the accompanying drawings. Unless expressed otherwise, the same numbers in different accompanying drawings represent the same or similar elements when the accompanying drawings are described hereinafter. The implementation modes described in the following exemplary embodiments do not represent all the implementation modes consistent with the present disclosure. On the contrary, they are only examples of devices and methods as described in details in the appended claims and consistent with some aspects of the present disclosure.

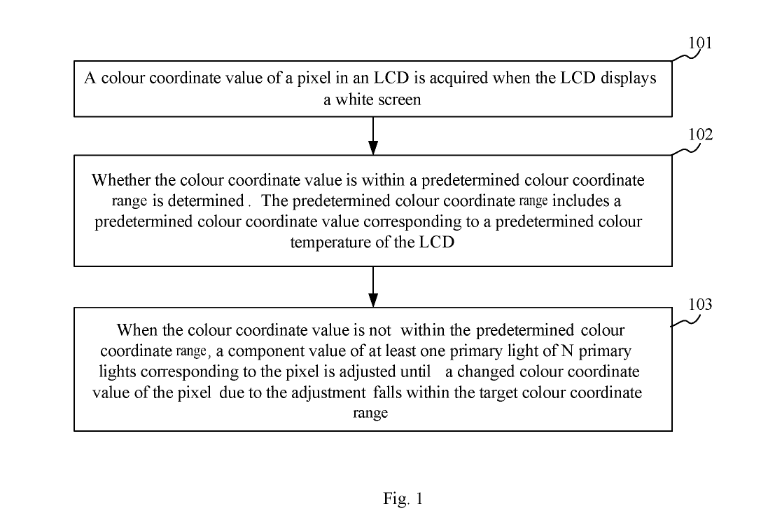

FIG. 1 is a flow chart of a method for adjusting a colour temperature according to an exemplary embodiment. The method for adjusting a colour temperature is applied in a terminal including an LCD. As shown in FIG. 1, the method for adjusting a colour temperature includes the following steps.

In Step 101, a colour coordinate value of a pixel in an LCD is acquired when the LCD displays a white screen.

In Step 102, whether the colour coordinate value is within a target colour coordinate range is determined. The target colour coordinate range is defined by a range of colour coordinate values in terms of a transverse axis and a vertical axis. The target colour coordinate range includes a target colour coordinate value and the target colour coordinate value is a colour coordinate value calculated according to a target colour temperature of the LCD.

In Step 103, when the colour coordinate value is not within the target colour coordinate range, a component value of at least one primary light of N primary lights corresponding to the pixel is adjusted until a changed colour coordinate value of the pixel due to the adjustment falls within the target colour coordinate range. N is a positive integer. The primary light may be a light emitting diode (LED).

To sum up, a colour temperature adjusting method provided by the present disclosure includes that a colour coordinate value of a pixel in an LCD is acquired when the LCD displays a white screen, whether the colour coordinate value is within a target colour coordinate range is determined. The target colour coordinate range includes a target colour coordinate value and the target colour coordinate value is a colour coordinate value calculated according to a target colour temperature of the LCD, and when the colour coordinate value is not within the target colour coordinate range, a component value of at least one primary light of N primary lights corresponding to the pixel is adjusted until the colour coordinate value of the pixel falls within the target colour coordinate range due to the adjustment. Since primary lights having different component values may be mixed mutually to generate lights with different colour temperatures, a component value of the primary lights may be adjusted so that a colour temperature acquired by mixing the adjusted primary lights reaches a target colour temperature, thereby solving the problem that the colour temperature of an LCD is not uniform when LEDs from different blocks are arranged crosswise on the LCD and improving the consistency of the colour temperature of the LCD.

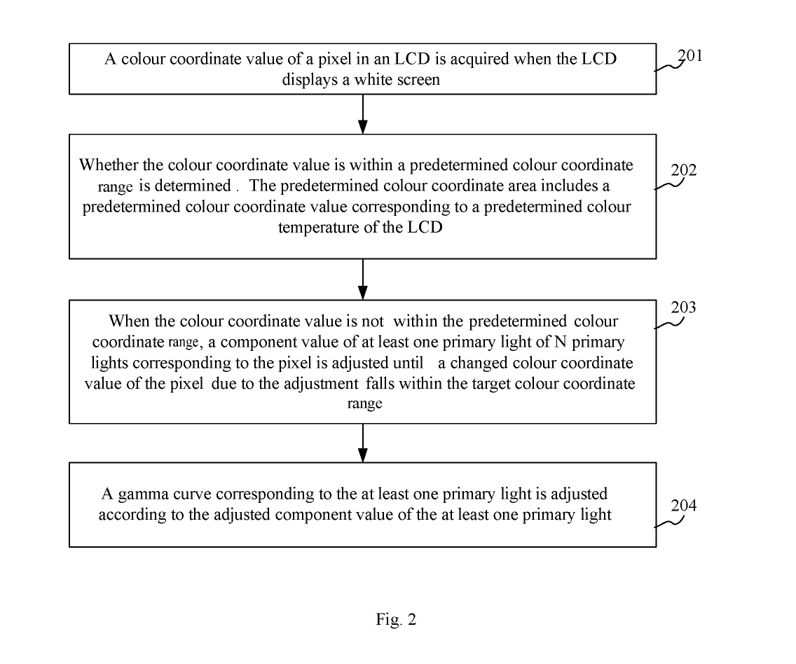

FIG. 2 is a flow chart of a method for adjusting a colour temperature according to another exemplary embodiment. The method for adjusting a colour temperature is applied in a terminal including an LCD. As shown in FIG. 2, the method for adjusting a colour temperature includes the following steps.

In Step 201, a colour coordinate value of a pixel in an LCD is acquired when the LCD displays a white screen.

A colour coordinate is for determining a point on a chromaticity diagram. The point represents a light colour corresponding to the colour coordinate. Generally, a transverse axis of the colour coordinate is an x axis while a vertical axis is a y axis, and thus a colour coordinate value is represented by (x, y). For example, a colour coordinate value of an incandescent colour is (0.463, 0.420).

A colour temperature, which is calculated according to the colour coordinate, has a corresponding relationship with the colour coordinate. For example, a colour temperature which is 7300 k corresponds to a colour coordinate value of (0.30, 0.32). It is a mature technology to calculate a colour temperature according to a colour coordinate, which will not be repeated here.

Since it is necessary to adjust the consistency of the colour temperature of the LCD in the present embodiment, the adjustment of the colour temperature of the LCD may be converted into adjustment of the colour coordinate value of the pixel in the LCD in an implementation mode. In the present embodiment, the colour coordinate value of the pixel is measured by a measuring device when the LCD displays the white screen. Since a central area of the LCD emits relatively uniform lights, a colour coordinate value of a pixel in the central area of the LCD may be measured in order to improve the accuracy of the colour coordinate value.

In Step 202, whether the colour coordinate value is in a target colour coordinate range is determined. The target colour coordinate range includes a target colour coordinate value and the target colour coordinate value is a colour coordinate value calculated according to a target colour temperature of the LCD.

In the present embodiment, the terminal may preset the target colour temperature of the LCD, then calculate the target colour coordinate value according to the target colour temperature, and then adjust the colour coordinate value of the pixel in the LCD to the target colour coordinate value, thereby ensuring the consistency of the colour temperature of the LCD.

Since it is difficult to adjust the colour coordinate value of the pixel to the target colour coordinate value precisely, the target colour coordinate range may be set based on the target colour coordinate value in order to reduce the difficulty in adjustment. A user has the same perception to a colour temperature corresponding to a colour coordinate value in the target colour coordinate range.

The target colour coordinate range may be calculated according to the target colour coordinate value. Provided that allowable errors of x and y in a colour coordinate value are both 0.005 and the target colour coordinate value is (0.30, 0.32), in this way, the target colour coordinate range is all coordinate values formed by four vertexes (0.295, 0.315), (0.305, 0.315), (0.295, 0.325) and (0.305, 0.325).

The step that the terminal determines whether the colour coordinate value is in the target colour coordinate range includes that when the colour coordinate value is in the target colour coordinate range, it is determined that it is unnecessary to adjust the colour temperature of the LCD and the flow is terminated. Otherwise, it is determined that the colour temperature of the LCD needs to be adjusted, and Step 203 is executed.

In Step 203, when the colour coordinate value is not in the target colour coordinate range, a component value of at least one primary light of N primary lights corresponding to the pixel is adjusted until the colour coordinate value of the pixel falls within the target colour coordinate range due to the adjustment. N is a positive integer.

Since a light colour of the pixel is acquired by mixing N primary lights, and different light colours are acquired when primary lights having different component values are mixed. Therefore, the colour temperature of the pixel is related to a component value of a primary light, and the component value of the at least one primary light of the N primary lights corresponding to the pixel may be adjusted when it is necessary to adjust the colour coordinate value of the pixel. A component value is for indicating the proportion of a primary light in a light colour, and the sum of component values of all primary lights is equal to 1,

Adjusting the component value of the at least one primary light of the N primary lights corresponding to the pixel includes adjusting a driving voltage value of a liquid crystal corresponding to the at least one primary light of the N primary lights. The driving voltage value is in a positive correlation relationship with the component value.

For each primary light, a component value of a primary light is determined by a grey scale of the primary light and the grey scale of the primary light is determined by a deflection angle of a corresponding liquid crystal while the deflection angle of the corresponding liquid crystal is controlled by a driving voltage corresponding to the corresponding liquid crystal, thus adjustment of the component value of the primary light may be converted into adjustment of a driving voltage value of the liquid crystal corresponding to the primary light. A driving voltage controls a liquid crystal corresponding to a primary light. The larger the driving voltage value is, the larger a deflection angle of the liquid crystal is and the higher the light transmittance is, thereby resulting in a larger grey scale of the primary light and a larger component value of the primary light. The primary light is blue light, red light or green light, and adjusting the driving voltage value of the liquid crystal corresponding to the at least one primary light of the N primary lights includes the following steps.

1) Whether the colour temperature of the pixel is higher or lower than the target colour temperature is determined according to the colour coordinate value. 2) When the colour temperature of the pixel is higher than the target colour temperature, at least one operation of increasing a driving voltage value of a liquid crystal corresponding to the blue light, reducing a driving voltage value of a liquid crystal corresponding to the red light and reducing a driving voltage value of a liquid crystal corresponding to the green light is executed. 3) When the colour temperature of the pixel is lower than the target colour temperature, at least one operation of reducing a driving voltage value of a liquid crystal corresponding to the blue light, increasing a driving voltage value of a liquid crystal corresponding to the red light and increasing a driving voltage value of a liquid crystal corresponding to the green light is executed.

When the colour temperature of the pixel is higher than the target colour temperature, it is indicated that the light colour of the pixel is a warm colour, and at least one operation of increasing the driving voltage value of the liquid crystal corresponding to the blue light, reducing the driving voltage value of the liquid crystal corresponding to the red light and reducing the driving voltage value of the liquid crystal corresponding to the green light needs to be executed accordingly. For example, only the driving voltage value of the liquid crystal corresponding to the blue light is increased, or only the driving voltage value of the liquid crystal corresponding to the red light is reduced, or the driving voltage values of the liquid crystals corresponding to the red light and the green light are reduced simultaneously, or the driving voltage value of the liquid crystal corresponding to the blue light is increased while the driving voltage values of the respective liquid crystals corresponding to the red light and the green light are reduced, and so on.

Since the green light, the red light and the blue light are primary lights which have an effect on the luminance of the LCD from the most significance to the least significance, the driving voltage value of the liquid crystal corresponding to the blue light may be increased preferentially, and the driving voltage values of the liquid crystals corresponding to the red light and the green light are reduced subsequently so as to reduce the influence due to the adjustment of the component value of the primary lights on the luminance.

In a first implementation mode, the step that at least one operation of increasing the driving voltage value of the liquid crystal corresponding to the blue light, reducing the driving voltage value of the liquid crystal corresponding to the red light and reducing the driving voltage value of the liquid crystal corresponding to the green light is executed includes increasing the driving voltage value of the liquid crystal corresponding to the blue light, and after the driving voltage value of the liquid crystal corresponding to the blue light reaches a voltage limit value of the blue light, executing at least one operation of reducing the driving voltage value of the liquid crystal corresponding to the red light and reducing the driving voltage value of the liquid crystal corresponding to the green light.

In this implementation mode, when the driving voltage value of the liquid crystal corresponding to the blue light is increased, the terminal may increase the driving voltage value by a predetermined amount. For example, if the predetermined amount is set as 0.05 v, then the terminal may increase the driving voltage value of the liquid crystal corresponding to the blue light by 0.05 v each time, and determine whether a current colour coordinate value is in the target colour coordinate range, and if the current coordinate value is not in the target colour coordinate range, then continue increasing the driving voltage value of the liquid crystal corresponding to the blue light by 0.05 v, otherwise, terminate the adjusting flow. Or the terminal may vary a predetermined amount and increase the driving voltage value according to the varying predetermined amount. For example, if an initial predetermined amount is 0.2 v, then the terminal increases the driving voltage value of the liquid crystal corresponding to the blue light by 0.2 v, and determines whether a current colour coordinate value is in the target colour coordinate range. If the current colour coordinate value is not in the target range and is larger than the maximum value of the target colour coordinate range, then sets the predetermined amount as −0.1 v, and reduces the driving voltage value of the liquid crystal corresponding to the blue light by 0.1 v. If the current colour coordinate value is not in the target range and is smaller than the maximum value of the target colour coordinate range, then sets the predetermined amount as 0.2 v, and continues increasing the driving voltage value of the liquid crystal corresponding to the blue light by 0.2 v.

The terminal may set a voltage limit value for each primary light and limit a driving voltage value of a liquid crystal corresponding to a primary light to be smaller than or equal to the voltage limit value. If the colour coordinate value is still not in the target colour coordinate range when the driving voltage value of the liquid crystal corresponding to the blue light reaches the voltage limit value of the blue light, then at least one operation of reducing the driving voltage value of the liquid crystal corresponding to the red light and reducing the driving voltage value of the liquid crystal corresponding to the green light needs to be executed. The processes of reducing the driving voltage value of the liquid crystal corresponding to the red light and reducing the driving voltage value of the liquid crystal corresponding to the green light are similar to the process of increasing the driving voltage value of the liquid crystal corresponding to the blue light and will not be described repeatedly here.

When the colour temperature of the pixel is lower than the target colour temperature, it is indicated that the light colour of the pixel is a cool colour, and at least one operation of reducing the driving voltage value of the liquid crystal corresponding to the blue light, increasing the driving voltage value of the liquid crystal corresponding to the red light and increasing the driving voltage value of the liquid crystal corresponding to the green light needs to be executed at the moment. For example, only the driving voltage value of the liquid crystal corresponding to the blue light is reduced, or only the driving voltage value of the liquid crystal corresponding to the red light is increased, or the driving voltage values of the liquid crystals corresponding to the red light and the green light are increased simultaneously, or the driving voltage value of the liquid crystal corresponding to the blue light is reduced while the driving voltage values of the liquid crystals corresponding to the red light and the green light are increased, and so on.

Since the decrease of a component value of the primary lights may reduce the luminance of the LCD, the driving voltage values of the liquid crystals respectively corresponding to the red light and the green light may be increased preferentially and the driving voltage value of the liquid crystal corresponding to the blue light is reduced subsequently so as to reduce the influence due to the adjustment of the component value of the primary lights on the luminance.

In a second implementation mode, the step that at least one operation of reducing the driving voltage value of the liquid crystal corresponding to the blue light, increasing the driving voltage value of the liquid crystal corresponding to the red light and increasing the driving voltage value of the liquid crystal corresponding to the green light is executed includes executing at least one operation of increasing the driving voltage value of the liquid crystal corresponding to the red light and increasing the driving voltage value of the liquid crystal corresponding to the green light is executed, and after the driving voltage values of the liquid crystals corresponding to the red light and the green light reach their respective voltage limit values, reducing the driving voltage value of the liquid crystal corresponding to the blue light. The processes of increasing the driving voltage values of the respective liquid crystals corresponding to the red light and the green light are similar to the process of increasing the driving voltage value of the liquid crystal corresponding to the blue light and will not be described repeatedly here.

In Step 204, a gamma curve corresponding to the at least one primary light is adjusted according to the adjusted component value of the at least one primary light, and an adjustment pattern of the gamma curve is the same as that of the component value.

Since the display effect of the LCD is also related to the luminance and the contrast, after the component value of the primary lights is adjusted to make the colour coordinate value of the pixel located in the target colour coordinate range, the terminal further needs to adjust the gamma curve of the primary lights so as to adjust the luminance and the contrast of the LCD to improve the display effect of the LCD. For example, a gamma curve of the blue light needs to be adjusted after a component value of the blue light is adjusted, and gamma curves of the red light and the green light need to be adjusted respectively after component values of the green light and the red light are adjusted. The adjustment pattern of a gamma curve is the same as that of a component value. For example, a gamma curve is shifted upwards in a translational manner when a component value of the primary lights is increased, and is shifted downwards in a translational manner when the component value of the primary lights is reduced.

It may be learned from the curve characteristics of a gamma curve that a smaller grey scale will bring less change in the luminance and a larger grey scale will bring more change in the luminance. Therefore, an adjustment range of the gamma curve may be set by segments so as to improve the adjustment accuracy of the gamma curve. For example, a first adjustment range is set for a gamma curve having a relatively small grey scale, a second adjustment range is set for a gamma curve having a relatively large grey scale, and the first adjustment range is smaller than the second adjustment range. The adjustment range for the gamma curve may be a value acquired through calculation, or an empirical value, which is not limited by the present embodiment.

To sum up, the colour temperature adjusting method provided by the present disclosure includes that a colour coordinate value of a pixel in an LCD is acquired when the LCD displays a white screen. It is determined whether the colour coordinate value is in a target colour coordinate range. The target colour coordinate range includes a target colour coordinate value and the target colour coordinate value is a colour coordinate value calculated according to a target colour temperature of the LCD. If the colour coordinate value is not in the target colour coordinate range, a component value of at least one primary light of N primary lights corresponding to the pixel is adjusted until the colour coordinate value of the pixel falls within the target colour coordinate range due to the adjustment. Since primary lights having different component values may be mixed mutually to generate lights with different colour temperatures, a component value of the primary lights may be adjusted so that a colour temperature acquired by mixing the adjusted primary lights reaches a target colour temperature, thereby solving the problem that the colour temperature of an LCD is still not uniform when LEDs from different blocks are arranged crosswise on the LCD and improving the consistency of the colour temperature of the LCD.

In addition, the gamma curve corresponding to the at least one primary light is adjusted according to the adjusted component value of the at least one primary light, and the adjustment pattern of the gamma curve is the same as that of the component value, so that the luminance and the contrast of the LCD are adjusted after the colour temperature of the LCD is adjusted, thereby improving the display effect of the LCD.

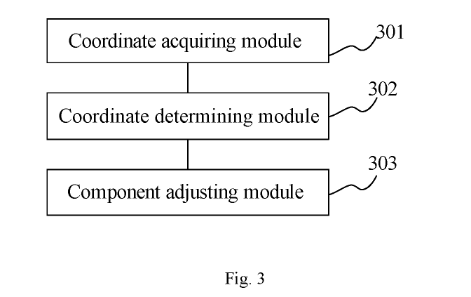

FIG. 3 is a block diagram of a device for adjusting a colour temperature according to an exemplary embodiment. The device for adjusting a colour temperature is applied in a terminal including an LCD. As shown in FIG. 3, the device for adjusting a colour temperature includes a coordinate acquiring module 301, a coordinate determining module 302 and a component adjusting module 303.

The coordinate acquiring module 301 is configured to acquire a colour coordinate value of a pixel in the LCD when the LCD displays a white screen.

The coordinate determining module 302 is configured to determine whether the colour coordinate value acquired by the coordinate acquiring module 301 is within a target colour coordinate range. The target colour coordinate range includes a target colour coordinate value and the target colour coordinate value is a colour coordinate value calculated according to a target colour temperature of the LCD.

The component adjusting module 303 is configured to, when the coordinate determining module 302 determines that the colour coordinate value is not in the target colour coordinate range, adjust a component value of at least one primary light of N primary lights corresponding to the pixel until a changed colour coordinate value of the pixel due to the adjustment falls within the target colour coordinate range. N is a positive integer.

To sum up, the colour temperature adjusting device provided by the present disclosure acquires a colour coordinate value of a pixel in an LCD when the LCD displays a white screen, determines whether the colour coordinate value is within a target colour coordinate range, the target colour coordinate range including a target colour coordinate value corresponding to a target colour temperature of the LCD. If the colour coordinate value is not within the target colour coordinate range, adjusts a component value of at least one primary light of N primary lights corresponding to the pixel until the colour coordinate value of the pixel falls within the target colour coordinate range due to the adjustment. Since primary lights having different component values may be mixed mutually to generate lights with different colour temperatures, a component value of the primary lights may be adjusted so that a colour temperature acquired by mixing the adjusted primary lights reaches a target colour temperature, thereby solving the problem that the colour temperature of an LCD is still not uniform when LEDs from different blocks are arranged crosswise on the LCD and improving the consistency of the colour temperature of the LCD.

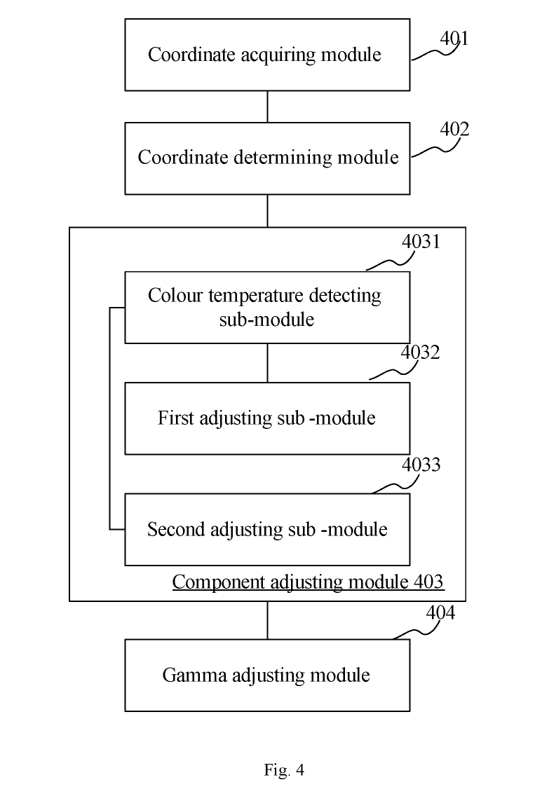

FIG. 4 is a block diagram of a device for adjusting a colour temperature according to an exemplary embodiment. The device for adjusting a colour temperature is applied in a terminal containing an LCD. As shown in FIG. 4, the device for adjusting a colour temperature includes a coordinate acquiring module 401, a coordinate determining module 402 and a component adjusting module 403.

The coordinate acquiring module 401 is configured to acquire a colour coordinate value of a pixel in the LCD when the LCD displays a white screen.

The coordinate determining module 402 is configured to determine whether the colour coordinate value acquired by the coordinate acquiring module 401 is within a target colour coordinate range. The target colour coordinate range includes a target colour coordinate value and the target colour coordinate value is a colour coordinate value calculated according to a target colour temperature of the LCD.

The component adjusting module 403 is configured to, when the coordinate determining module 402 determines that the colour coordinate value is not within the target colour coordinate range, adjust a component value of at least one primary light of N primary lights corresponding to the pixel until a changed colour coordinate value of the pixel due to the adjustment falls within the target colour coordinate range. N is a positive integer.

The component adjusting module 403 may be further configured to adjust a driving voltage value of a liquid crystal corresponding to the at least one primary light of the N primary lights. The driving voltage value is in a positive correlation relationship with the component value.

The component adjusting module 403 may include a colour temperature determining sub-module 4031, a first adjusting sub-module 4032 and a second adjusting sub-module 4033.

The colour temperature determining sub-module 4031 is configured to determine, according to the colour coordinate value, whether the colour temperature of the pixel is higher or lower than the target colour temperature.

The first adjusting sub-module 4032 is configured to execute, when the colour temperature determining sub-module 4031 determines that the colour temperature of the pixel is higher than the target colour temperature, at least one operation of increasing a driving voltage value of a liquid crystal corresponding to the blue light, reducing a driving voltage value of a liquid crystal corresponding to the red light and reducing a driving voltage value of a liquid crystal corresponding to the green light.

The second adjusting sub-module 4033 is configured to execute, when the colour temperature determining sub-module 4031 determines that the colour temperature of the pixel is lower than the target colour temperature, at least one operation of reducing a driving voltage value of a liquid crystal corresponding to the blue light, increasing a driving voltage value of a liquid crystal corresponding to the red light and increasing a driving voltage value of a liquid crystal corresponding to the green light.

The first adjusting sub-module 4032 may be further configured to increase the driving voltage value of the liquid crystal corresponding to the blue light, and after the driving voltage value of the liquid crystal corresponding to the blue light reaches a voltage limit value of the blue light, execute at least one operation of reducing the driving voltage value of the liquid crystal corresponding to the red light and reducing the driving voltage value of the liquid crystal corresponding to the green light.

The second adjusting sub-module 4033 may be further configured to execute at least one operation of increasing the driving voltage value of the liquid crystal corresponding to the red light and increasing the driving voltage value of the liquid crystal corresponding to the green light, and after the driving voltage values of the liquid crystals corresponding to the red light and the green light reach their respective voltage limit values, reduce the driving voltage value of the liquid crystal corresponding to the blue light.

The colour temperature adjusting device further includes a gamma adjusting module 404. The gamma adjusting module 404 is configured to adjust, according to the adjusted component value of the at least one primary light after the adjustment by the component adjusting module 403, a gamma curve corresponding to the at least one primary light. An adjustment pattern of the gamma curve is the same as that of the component value.

To sum up, the colour temperature adjusting device provided by the present disclosure acquires a colour coordinate value of a pixel in an LCD when the LCD displays a white screen, determines whether the colour coordinate value is in a target colour coordinate range. The target colour coordinate range includes a target colour coordinate value and the target colour coordinate value is a colour coordinate value calculated according to a target colour temperature of the LCD. If the colour coordinate value is not in the target colour coordinate range, the device adjusts a component value of at least one primary light of N primary lights corresponding to the pixel until the colour coordinate value of the pixel falls within the target colour coordinate range due to the adjustment. Since primary lights having different component values may be mixed mutually to generate lights with different colour temperatures, a component value of the primary lights may be adjusted so that a colour temperature acquired by mixing the adjusted primary lights reaches a target colour temperature, thereby solving the problem that the colour temperature of an LCD is still not uniform when LEDs of different blocks are arranged crosswise on the LCD and improving the consistency of the colour temperature of the LCD.

Besides, a gamma curve corresponding to the at least one primary light is adjusted according to the adjusted component value of the at least one primary light, and the adjustment pattern of the gamma curve is the same as that of the component value, so that the luminance and the contrast of the LCD are adjusted after the colour temperature of the LCD is adjusted, thereby improving the display effect of the LCD.

A specific manner for each module in the devices in the foregoing embodiments to execute an operation has been described in details in embodiments related to the methods and will not be elaborated herein.

An exemplary embodiment of the present disclosure provides a device for adjusting a colour temperature, which can implement a colour temperature adjusting method provided by the present disclosure. The device for adjusting a colour temperature of the LCD includes a processor, and a memory configured to store an instruction executable by the processor. The processor is configured to acquire a colour coordinate value of a pixel in an LCD when the LCD displays a white screen, determine whether the colour coordinate value is within a predetermined colour coordinate range, predetermined colour coordinate range including a target colour coordinate value corresponding to a target colour temperature of the LCD, and if the colour coordinate value is not within the target colour coordinate range, adjust a component value of at least one primary light of N primary lights corresponding to the pixel until a changed colour coordinate value of the pixel due to the adjustment falls within the target colour coordinate range. N is a positive integer.

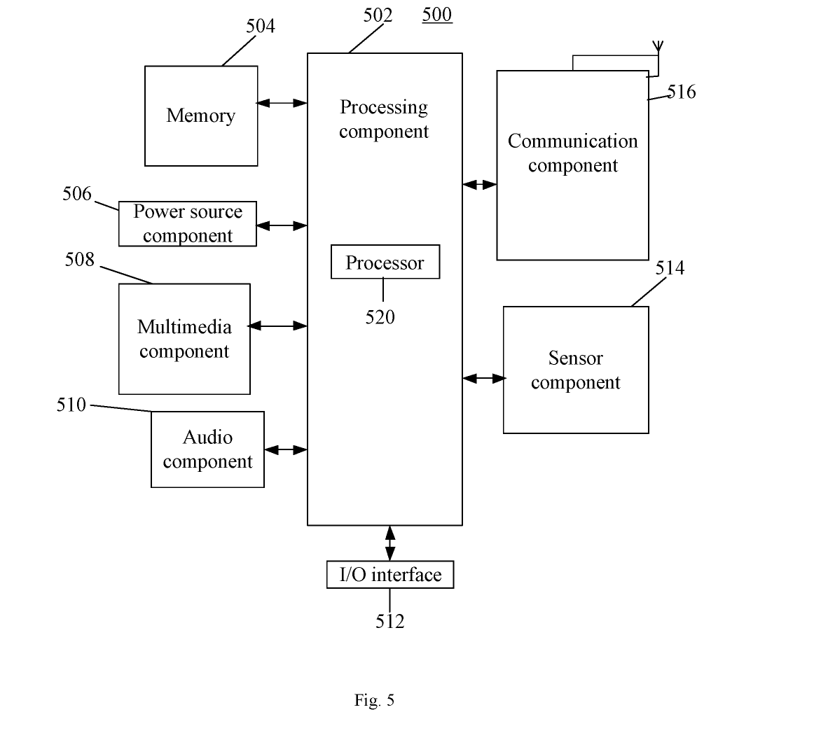

FIG. 5 is a block diagram of a device 500 for adjusting a colour temperature according to an exemplary embodiment. For example, the device 500 may be a mobile phone, a computer, a digital broadcasting terminal, a message transceiver, a game console, a tablet device, a medical device, fitness equipment, a personal digital assistant and so on.

Referring to FIG. 5, the device 500 may include at least one of following components: a processing component 502, a memory 504, a power source component 506, a multimedia component 508, an audio component 510, an Input/Output (I/O) interface 512, a sensor component 514 and a communication component 516.

Generally, the processing component 502 controls overall operations of the device 500, such as operations related to display, telephone calls, data communication, camera operations, and recording operations. The processing component 502 may include one or more processors 518 to execute instructions so as to complete all or some steps of the foregoing methods. Besides, the processing component 502 may include one or more modules to facilitate interaction between the processing component 502 and other components. For example, the processing component 502 may include a multimedia module to facilitate interaction between the multimedia component 508 and the processing component 502.

The memory 504 is configured to store various types of data so as to support operations in the device 500. Examples of these data include an instruction of any application or method operated on the device 500, data of contacts, data of a telephone directory, a message, an image, a video, and so on. The memory 504 may be implemented by volatile or non-volatile memory devices of any types or their combinations, such as a Static Random Access Memory (SRAM), an Electrically Erasable Programmable Read-Only Memory (EEPROM), an Erasable Programmable Read-Only Memory (EPROM), a Programmable Read-Only Memory (PROM), a Read-Only Memory (ROM), a magnetic memory, a flash memory, a magnetic disk or an optical disk.

The power source component 506 provides power for various components of the device 500. The power source component 506 may include a power source management system, one or more power sources, and other components related to generation, management and power distribution of the device 500.

The multimedia component 508 includes a screen providing an output interface between the device 500 and a user. In some embodiments, the screen may include an LCD and a Touch Panel (TP). The screen may be implemented as a touch screen so as to receive an input signal from the user if including the TP. The TP includes one or more touch sensors so as to sense a touch, a slide, and a gesture on the TP. The touch sensor may not only sense a boundary of a touch or a slide, but also determine a duration and a pressure related to the touch or the slide. In some embodiments, the multimedia component 508 includes a front camera and/or a rear camera. When the device 500 is in an operation mode, such as a camera mode or a video mode, the front camera and/or the rear camera may receive external multimedia data. Each front camera and rear camera may be a fixed optical lens system or provided with a focal length and an optical zooming capability.

The audio component 510 is configured to output and/or input an audio signal. For example, the audio component 510 includes a Microphone (MIC). When the device 500 is in an operation mode, such as a calling mode, a recording mode and a voice recognition mode, the MIC is configured to receive an external audio signal, and the received audio signal may be further stored in the memory 504 or transmitted by the communication component 516. In some embodiments, the audio component 510 further includes a loudspeaker configured to output the audio signal.

The I/O interface 512 provides an interface between the processing component 502 and a peripheral interface module. The peripheral interface module may be a keyboard, a click wheel, buttons and so on. These buttons may include, but are not limited to, a home button, a volume button, a start button and a lock button.

The sensor component 514 includes one or more sensors for providing evaluation of states in various aspects for the device 500. For example, the sensor component 514 may determine an on/off state of the device 500, a relative location of a component, e.g. the component is a display and a keypad of the device 500. The sensor component 514 may also determine a change in the location of the device 500 or a change in the location of a component of the device 500, the existence of a contact between a user and the device 500, the location or acceleration/deceleration of the device 500, and a change in the temperature of the device 500. The sensor component 514 may include a proximity sensor configured to determine the existence of a nearby object when there is no any physical contact. The sensor component 514 may further include an optical sensor, such as a Complementary Metal Oxide Semiconductor (CMOS) image sensor or a Charge-Coupled Device (CCD) image sensor used in an imaging application. In some embodiments, the sensor component 514 may further include an acceleration sensor, a gyroscopic sensor, a magnetic sensor, a pressure sensor or a temperature sensor.

The communication component 516 is configured to facilitate wire or wireless communication between the device 500 and other devices. The device 500 may access a communications standard based wireless network, such as Wireless Fidelity (WiFi), the 2^{nd} Generation (2G), or the 3^{rd} generation (3G), or a combination of them. In an exemplary embodiment, the communication component 516 receives a broadcast signal or broadcast-related information from an external broadcast management system via a broadcast channel. In an exemplary embodiment, the communication component 516 may further include a Near Field

Communication (NFC) module so as to promote short range communication. For example, the NFC module may be implemented based on a Radio Frequency Identification (RFID) technology, an Infrared Data Association (IrDA) technology, an Ultra-Wideband (UWB) technology, a Bluetooth (BT) technology and other technologies.

In an exemplary embodiment, the device 500 may be implemented by one or more Application Specific Integrated Circuits (ASIC), Digital Signal Processors (DSP), Digital Signal Processing Devices (DSPD), Programmable Logic Devices (PLD), Field Programmable Gate Arrays (FPGA), controllers, microcontrollers, microprocessors, or other electronic elements, so as to implement the foregoing methods.

A non-temporary computer readable storage medium including an instruction is further provided in an exemplary embodiment, such as the memory 504 including an instruction. The instruction may be executed by the processor 518 of the device 500 so as to complete the foregoing methods. For example, the non-temporary computer readable storage medium may be a ROM, a Random Access Memory (RAM), a Compact Disc ROM (CD-ROM), a magnetic tape, a floppy disk, an optical data storage device and so on.

Each module discussed above, such as the coordinate acquiring module 301, the coordinate determining module 302 and the component adjusting module 303, may take the form of a packaged functional hardware unit designed for use with other components, a portion of a program code (e.g., software or firmware) executable by the processor or the processing circuitry that usually performs a particular function of related functions, or a self-contained hardware or software component that interfaces with a larger system, for example.

Those skilled in the art might easily think of other embodiments of the present disclosure after consideration of the specification and practice of the present disclosure. The present application aims to cover any variations, applications, or adaptive changes of the present disclosure. These variations, applications, or adaptive changes follow general principles of the present disclosure and include undisclosed common knowledge or conventional technical means in the technical field of the present disclosure. The specification and embodiments should be only considered exemplary, and the true scope and spirit of the present disclosure are indicated by the following claims.

It should be understood that the present disclosure is not limited to the precise structure described above and illustrated in the accompanying drawings, and various modifications and changes may be made without departing from the scope of the present disclosure. The scope of the present disclosure is limited only by the appended claims.

In the embodiments of the present disclosure, a colour coordinate value of a pixel in an LCD is acquired when the LCD displays a white screen. It is determined whether the colour coordinate value is within a target colour coordinate range. The target colour coordinate range includes a target colour coordinate value and the target colour coordinate value is a colour coordinate value calculated according to a target colour temperature of the LCD. If the colour coordinate value is not within the target colour coordinate range, then a component value of at least one primary light of N primary lights corresponding to the pixel is adjusted until a changed colour coordinate value of the pixel due to the adjustment falls within the target colour coordinate range due to the adjustment. Since primary lights having different component values may be mixed mutually to generate lights with different colour temperatures, a component value of the primary lights may be adjusted so that a colour temperature acquired by mixing the adjusted primary lights reaches a target colour temperature, thereby solving the problem that the colour temperature of an LCD is still not uniform when LEDs from different blocks are arranged crosswise on the LCD and improving the consistency of the colour temperature of the LCD.

What is claimed is:

1. A method for adjusting a colour temperature of a liquid crystal display (LCD), comprising:
acquiring a colour coordinate value of a pixel in the LCD when the LCD displays a white screen;
determining whether the colour coordinate value is within a predetermined colour coordinate range corresponding to a predetermined colour temperature of the LCD; and
when the colour coordinate value is not within the predetermined colour coordinate range, adjusting a component value of at least one light emitting diode (LED) of N LEDs corresponding to the pixel until a changed colour coordinate value of the pixel due to the adjustment falls within the predetermined colour coordinate range, wherein N is a positive integer.

2. The method according to claim 1, wherein adjusting the component value of the at least one LED of the N LEDs corresponding to the pixel comprises:
adjusting a driving voltage value of a liquid crystal corresponding to the at least one LED of the N LEDs, wherein the driving voltage value is in a positive correlation relationship with the component value.

3. The method according to claim 2, wherein the LED is blue light, red light or green light, and adjusting the driving voltage value of the liquid crystal corresponding to the at least one LED of the N LEDs comprises:
determining whether a colour temperature of the pixel is higher or lower than the predetermined colour temperature based on the colour coordinate value;
when the colour temperature of the pixel is higher than the predetermined colour temperature, executing at least one operation of increasing a driving voltage value of a liquid crystal corresponding to the blue light, reducing a driving voltage value of a liquid crystal corresponding to the red light and reducing a driving voltage value of a liquid crystal corresponding to the green light; and
when the colour temperature of the pixel is lower than the predetermined colour temperature, executing at least one operation of reducing a driving voltage value of a liquid crystal corresponding to the blue light, increasing a driving voltage value of a liquid crystal corresponding to the red light and increasing a driving voltage value of a liquid crystal corresponding to the green light.

4. The method according to claim 3, wherein executing at least one operation of increasing the driving voltage value of the liquid crystal corresponding to the blue light, reducing the driving voltage value of the liquid crystal corresponding to the red light and reducing the driving voltage value of the liquid crystal corresponding to the green light comprises:
increasing the driving voltage value of the liquid crystal corresponding to the blue light;
determining whether the driving voltage value of the liquid crystal corresponding to the blue light reaches a voltage limit value of the blue light; and
executing at least one operation of reducing the driving voltage value of the liquid crystal corresponding to the red light and reducing the driving voltage value of the liquid crystal corresponding to the green light when the driving voltage value of the liquid crystal corresponding to the blue light reaches the voltage limit value.

5. The method according to claim 3, wherein executing at least one operation of reducing the driving voltage value of the liquid crystal corresponding to the blue light, increasing the driving voltage value of the liquid crystal corresponding to the red light and increasing the driving voltage value of the liquid crystal corresponding to the green light comprises:
executing at least one operation of increasing the driving voltage value of the liquid crystal corresponding to the red light and increasing the driving voltage value of the liquid crystal corresponding to the green light;
determining whether the driving voltage values of the liquid crystals corresponding to the red light and the green light reach their respective voltage limit values; and
reducing the driving voltage value of the liquid crystal corresponding to the blue light when the driving voltage values of the liquid crystals corresponding to the red light and the green light reach their respective voltage limit values.

6. The method according to claim 1, further comprising:
adjusting, based on the adjusted component value of the at least one LED, a gamma curve corresponding to the at least one LED, wherein an adjustment pattern of the gamma curve corresponds to that of the component value.

7. The method according to claim 2, further comprising:
adjusting, based on the adjusted component value of the at least one LED, a gamma curve corresponding to the at least one LED, wherein an adjustment pattern of the gamma curve corresponds to that of the component value.

8. The method according to claim 3, further comprising:
adjusting, based on the adjusted component value of the at least one LED, a gamma curve corresponding to the at least one LED, wherein an adjustment pattern of the gamma curve corresponds to that of the component value.

9. The method according to claim 4, further comprising:
adjusting, based on the adjusted component value of the at least one LED, a gamma curve corresponding to the at least one LED, wherein an adjustment tendency of the gamma curve corresponds to that of the component value.

10. The method according to claim 5, further comprising:
adjusting, according to the adjusted component value of the at least one LED, a gamma curve corresponding to the at least one LED, wherein an adjustment tendency of the gamma curve corresponds to that of the component value.

11. A device for adjusting a colour temperature of Liquid Crystal Display (LCD), comprising:
a processor; and
a memory for storing instructions executable by the processor,
wherein the processor is configured to:
acquire a colour coordinate value of a pixel in an LCD when the LCD displays a white screen;
determine whether the colour coordinate value is within a predetermined colour coordinate range, wherein the predetermined colour coordinate range corresponding to a predetermined colour temperature of the LCD; and
when the colour coordinate value is not within the predetermined colour coordinate range, adjust a component value of at least one LED of N LEDs corresponding to the pixel until a changed colour coordinate value of the pixel due to the adjustment falls within the predetermined colour coordinate range, wherein N is a positive integer.

12. The device according to claim 11, wherein the processor is further configured to adjust a driving voltage value of a liquid crystal corresponding to the at least one LED of the N LEDs, wherein the driving voltage value is in a positive correlation relationship with the component value.

13. The device according to claim 12, wherein the processor is further configured to:
determine whether a colour temperature of the pixel is higher or lower than the predetermined colour temperature based on the colour coordinate value;
execute, when the colour temperature determining sub-module determines that the colour temperature of the pixel is higher than the predetermined colour temperature, at least one operation of increasing a driving voltage value of a liquid crystal corresponding to the blue light, reducing a driving voltage value of a liquid crystal corresponding to the red light and reducing a driving voltage value of a liquid crystal corresponding to the green light; and
execute, when the colour temperature determining sub-module determines that the colour temperature of the pixel is lower than the predetermined colour temperature, at least one operation of reducing a driving voltage value of a liquid crystal corresponding to the blue light, increasing a driving voltage value of a liquid crystal corresponding to the red light and increasing a driving voltage value of a liquid crystal corresponding to the green light.

14. The device according to claim 13, wherein the processor is further configured to:
increase the driving voltage value of the liquid crystal corresponding to the blue light;
determine whether the driving voltage value of the liquid crystal corresponding to the blue light reaches a voltage limit value of the blue light; and
execute at least one operation of reducing the driving voltage value of the liquid crystal corresponding to the red light and reducing the driving voltage value of the liquid crystal corresponding to the green light when the driving voltage value of the liquid crystal corresponding to the blue light reaches the voltage limit value.

15. The device according to claim 13, wherein the processor is further configured to:
execute at least one operation of increasing the driving voltage value of the liquid crystal corresponding to the red light and increasing the driving voltage value of the liquid crystal corresponding to the green light; and
determine whether the driving voltage values of the liquid crystals corresponding to the red light and the green light reach their respective voltage limit values; and
reduce the driving voltage value of the liquid crystal corresponding to the blue light when the driving voltage values of the liquid crystals corresponding to the red light and the green light reach their respective limit voltage values.

16. The device according to claim 11, wherein the processor is further configured to:
adjust, based on the adjusted component value of the at least one LED after the adjustment made by the component adjusting module, a gamma curve corresponding to the at least one LED, wherein an adjustment pattern of the gamma curve corresponds to that of the component value.

17. The device according to claim 12, wherein the processor is further configured to:
adjust, based on the adjusted component value of the at least one LED after the adjustment made by the component adjusting module, a gamma curve corresponding to the at least one LED, wherein an adjustment pattern of the gamma curve corresponds to that of the component value.

18. The device according to claim 13, wherein the processor is further configured to:
adjust, based on the adjusted component value of the at least one LED after the adjustment made by the component adjusting module, a gamma curve corresponding to the at least one LED, wherein an adjustment pattern of the gamma curve corresponds to that of the component value.

19. The device according to claim 14, wherein the processor is further configured to:
adjust, based on the adjusted component value of the at least one LED after the adjustment made by the component adjusting module, a gamma curve corresponding to the at least one LED, wherein an adjustment pattern of the gamma curve corresponds to that of the component value.

20. A non-transitory computer-readable storage medium having stored therein instructions that, when executed by a processor, causes the processor to perform a method for adjusting a colour temperature of a Liquid Crystal Display (LCD), the method comprising:
acquiring a colour coordinate value of a pixel in an LCD when the LCD displays a white screen;
determining whether the colour coordinate value is within a predetermined colour coordinate range corresponding to a predetermined colour temperature of the LCD; and
when the colour coordinate value is not within the predetermined colour coordinate range, adjusting a component value of at least one LED of N LEDs corresponding to the pixel until a changed colour coordinate value of the pixel due to the adjustment falls within the predetermined colour coordinate range, wherein N is a positive integer.
